(19) United States
(12) Patent Application Publication
(10) Pub. No.: US 2024/0029644 A1
(43) Pub. Date: Jan. 25, 2024

(54) OPTICAL SENSOR MODULE AND METHOD FOR BEHIND OLED AMBIENT LIGHT DETECTION

(71) Applicant: ams Sensors USA Inc., PLANO, TX (US)

(72) Inventors: Sue HUI, Plano, TX (US); Matthew SAMPSELL, Melissa, TX (US)

(73) Assignee: ams Sensors USA Inc., PLANO, TX (US)

(21) Appl. No.: 17/871,595

(22) Filed: Jul. 22, 2022

(51) Int. Cl. G09G 3/3208

(52) U.S. Cl. CPC G09G 3/3208; G09G 2360/144

(57) ABSTRACT

Optical sensor module (54) for detection of ambient light behind an OLED display (2), comprising a first optical sensor (56) and a second optical sensor (58), whereby the first optical sensor (56) is preceded by a polarizer (70).

### TECHNICAL FIELD OF THE DISCLOSURE

The invention relates to optical detection means of ambient light behind an OLED display.

### BACKGROUND

Many display devices such as cell phones, tablets, TVs are equipped with organic light emitting diode OLED displays which comprise display lights to display information to the user.

OLED display, in contrast to, for instance, LED display, do not need a backlight as the display lights emit light directly. OLED displays can reach higher contrasts than LED display.

It is desirable to adjust the intensity of the display lights of the OLED display with respect to the ambient light which is also impinging on the display.

If the ambient light intensity is high, the display lights of the OLED display are typically operated with high or increased intensity, allowing the user to clearly recognize the display content.

In contrast, when the ambient light intensity is low, the display lights of the OLED display can be operated with low or decreased intensity, thereby avoiding blinding the user and reducing energy consumption which is especially relevant for mobile devices.

These OLED displays can comprise a circular polarizer directly below the first display layer/surface and a reflective backing on the other side of the display with a reflective backing, thereby reducing the amount of ambient light which is reflected back to the user.

In order to adjust the display lights intensity with respect to the ambient light intensity, an ambient light sensor is used. This task is especially difficult for non-blanking types of OLED displays.

In certain OLED displays with relatively low screen refresh rates, the ambient light could be easily detected from behind the OLED screen during the frame interval when the display is turned off and the screen is dark. In that case, the ambient light sensor senses only the ambient light without any display light. However, in the cases of non-blanking types of OLED displays, the screen never goes dark, or the dark interval is negligibly small due to very high display refresh rates. In that case, the ambient light sensor from behind the OLED screen will always detect a sum of the ambient light and the display light.

It is very difficult if not impossible to separate the ambient light from the mixed light when the screen display content is unknown and the characteristics of the ambient light are unknown. One known technical solution is to disable some pixels directly above and near the ambient light sensor so that the sensor could sense the ambient light without the interference of the display light. However, such solution has the disadvantage of losing a small portion of the display area.

### SUMMARY

The object of the invention is therefore to detect ambient light intensity accurately. A further object is to detect also the correlated color temperature accurately. A further object of the invention is to provide an optical sensor module, an optical sensor system, a display system and a method for accurate ambient light detection.

Regarding the optical sensor module this object is solved by an optical sensor module according to claim 1. The optical sensor module comprises a first optical sensor and a second optical sensor, whereby the first optical sensor is preceded by a polarizer.

The invention is based on the consideration that an accurate ambient light detection is of strong relevance for the efficient operation of OLED displays.

Applicant has found that these demands can be met by a sensor module comprising an architecture which uses two multispectral sensors plus one or two circular polarizers that precede(s) the sensors. In this way, one of the sensors detects/senses only display light, whereas the other sensor detects/senses ambient light plus display light. The difference of these two signals then can be processed to obtain a measure for the ambient light intensity.

In a first embodiment, the second sensor is preceded by no polarizer. In this way, costs are reduced as only one polarizer for the first sensor is needed.

In a second embodiment, the second sensor is preceded by a polarizer, whereby the polarizing direction of this polarizer is opposite to the polarization direction of the polarizer of the first sensor. In this way, a distinction between the light reaching the first sensor and the second can be made. The advantage of this sensor configuration is that it allows for higher ratio of the ambient light vs. display light because the display light is reduced through a polarizer with the additional cost of one extra polarizer.

Advantageously, the polarizers, i.e., the polarizers in front of both the first sensor and/or the second sensor, are circular polarizers.

In an embodiment, the first sensor and/or the second sensor comprises a diffuser. In a preferred variant, both sensors comprise a diffuser, respectively. The respective diffuser leads to a more homogenous distribution of the light reaching the sensor.

In a preferred embodiment, the optical sensors are multispectral sensors. In this way, light can be detected in a plurality of channels, which allows to accurately compute LUX and CCT values. Furthermore, the adjustment of the display lights of the OLED display can be performed for each channel separately. This is to achieve certain desired color temperature of the display for most comfortable viewing under a given ambient light. When the ambient light changes, the screen display brightness and color temperature should also change accordingly.

Preferably, the sensors detect light in the R, G, B channels, i.e., in the red, green and blue channels.

Preferably, the multispectral sensor detects light in multiple wavelengths in visible as well as in infrared light ranges. The multiple wavelengths include but not limited to narrowband lights such as red, green, blue, yellow, cyan, magenta, near IR, and broadband which includes all visible lights.

The term “optical sensor module” indicates preferably the components being part of the module and not necessarily that the sensors are arranged in a common housing or casing. Both sensors are advantageously arranged as close to each other as possible. In a preferred embodiment, both sensors are integrated into a single chip with two side by side sensing windows.

With respect to the optical sensor system, the objective is solved by an optical sensor module described above and a processing unit which on its input side is connected to both sensors.

In one embodiment, the ambient light sensor contains an embedded processor such as an ARM processor or other similar processors. The processing or computing is done by the embedded processor. In this case, the sensor data is transmitted internally from one part of the sensor to another part of the sensor. In another preferred embodiment where the ambient light sensor does not contain an embedded processor, the processing or computing is done on the host device such as a processor on a cell phone. In this case, the sensor data is transmitted through designated communication channel from the sensor to the host device.

The processing unit is preferably configured to process both sensor signals and to generate at least one output signal.

The processing unit is preferably configured to compute per channel ambient light signal and/or a LUX value and/or a CCT value.

With respect to the display system, the object is solved by an OLED display and an optical sensor module described above.

In an embodiment, the OLED display comprises an (outer) layer, display lights and a circular polarizer. The display lights are preferably R, G, B lights. The circular polarizer is preferably arranged between the display lights and the outer layer.

The OLED display between the sensors and the region/plane in which the display lights are arranged preferably comprises a reflective backing in which apertures are arranged above both sensors. The reflective backing reflects back the ambient light penetrating through the outer layer with an opposite polarization direction. This reflected light therefore does not penetrate the circular polarizer of the OLED display and does not penetrate the outer layer to the user's eye, thereby providing an improved contrast of the display.

The sensors are preferably arranged below the OLED display in a region which in at least one typical use case of the display in which the display is arranged corresponds to an upper region. For example, if the OLED display is arranged in a smartphone, the sensors/the optical sensor module is arranged close to the upper boarder of the display in portrait format. This is to ensure that the sensor is least likely to be obstructed from sensing the ambient light because a cell phone user most often touches the middle or lower part of the screen while the phone is being held in the portrait format.

In an embodiment, the polarizer of the first sensor has a polarizing direction opposite to the polarizing direction of the polarizer of the OLED display. In the configuration in which each sensor is preceded by a polarizer, the polarizer of the second sensor, having a polarization direction opposite to the polarizing direction of the polarizer of the first sensor, the polarizing direction of the polarizer of the second sensor coincides with the polarizing direction of the polarizer of the OLED display.

With respect to the method, the objective is solved by detecting light by two sensors arranged behind the OLED display of which at least one sensor is preceded by a polarizer, whereby a weighted difference of both signal sensors is computed representing ambient light.

When it is said here and above that the respective sensor is preceded by a polarizer, it essentially means that light which penetrates the display first penetrates through the polarizer first before it hits the sensor. The diffusers of the sensors are arranged in such a way that light which is penetrated the display first impinges on the diffuser before the diffused light than hits the sensor.

In a variant of the method, the ambient light per channel is computed as a weighted difference of the two sensor signals. In a preferred embodiment, for each channel, a function of the signal value of the second sensor is subtracted from the signal value of the first sensor. In one preferred embodiment, the function is defined by multiplying a constant with the signal value of the second sensor. The respective values of the constants are preferably determined by measurements and/or by simulations. In another example embodiment, functions f( ) and g( ) could also be Nth order polynomial functions, where N is an integer greater than 1. The exact order of the polynomial function will be determined by measurements and/or simulations.

The aspects of the present invention are one or two circular polarizers arranged before respective sensors, whereby one multispectral sensor senses only display light and one multispectral sensor senses ambient light plus display light. In this way, ambient light is derived from the differences between the two sensor outputs. The invention therefore proposes a new detection architecture which consists of two multispectral sensors with one or two circular polarizers.

The advantages of the invention are especially as follows. The ambient light intensity and correlated color temperature under any screen display conditions are accurately derived. This is especially applicable to the non-blanking type of OLED displays. The new architecture allows the detection of ambient light intensity and correlated color temperature accurately in behind OLED applications.

The advantage of the first configuration in which only the first sensor is preceded by a circular polarizer is lower cost with one less polarizer but stronger display light which may make the subtraction less accurate. The advantage of the second configuration in which both sensors are preceded by polarizers is that it allows for higher ratio of the ambient light vs. display light because the display light is reduced through a polarizer with the additional cost of one extra polarizer.

The second configuration also has the disadvantage of slightly reduced ambient light because it has to penetrate through an additional polarizer of the same direction which incurs some transmission loss.

### BRIEF DESCRIPTION OF THE DRAWINGS

A preferred embodiment of the invention is described in connection with a drawing. In this drawing,

FIG. 1 shows an OLED display,

FIG. 2 shows an apparatus with the OLED display according to FIG. 1 and an optical sensor module,

FIG. 3 shows an apparatus in a first preferred embodiment,

FIG. 4 shows an apparatus in a second preferred embodiment, and

FIG. 5 shows a flow chart of a method for ambient light measurement in a preferred embodiment.

Identical parts are labelled in all figures with the same reference signs.

### DETAILED DESCRIPTION

FIG. 1 shows an OLED display 2 with a display layer 6 built as a cover glass which in the mounted state in a device faces the user.

Below layer 6, a circular polarizer 10 is arranged to cut down ambient light reflection and thus to increase the display contrast. The OLED display 2 further comprises a mirror-like reflective backing 14 to increase R/G/B display light intensity of non-polarized display lights 20 arranged between reflective backing 14 and circular polarizer 10. In the present embodiment, three display lights 20 with the colors red (R), green (G) and blue (B) are present.

The display lights 20 emit non-polarized light towards the layer 6 and also towards the reflective backing 14. Due to the circular polarizer 10, polarized light 24 leaves the OLED display 2 and is visible to the user.

From the outside of OLED display 2, ambient light impinges on the layer 6 and penetrates layer 6 and circular polarizer 10. As circular polarizer 10 polarizes the ambient light 30 penetrating through, circularly polarized ambient light 34 is impinging on reflective backing 14. This polarized ambient light 34 is reflected back by the reflective backing 14 towards the circular polarizer, resulting in polarized ambient light 38 with a circular polarization in opposite direction to the polarized ambient light 34 which has been polarized by polarizer 10. It therefore does not penetrate back through circular polarizer 10. In this way, the amount of reflected ambient light 30 can be strongly reduced or fully eliminated.

Hence, due to the circular polarizer 10 and the mirror-like reflective backing 14 the display contrast is improved by reducing the reflected ambient light 30. The OLED display 2 is typically used in an OLED smartphone.

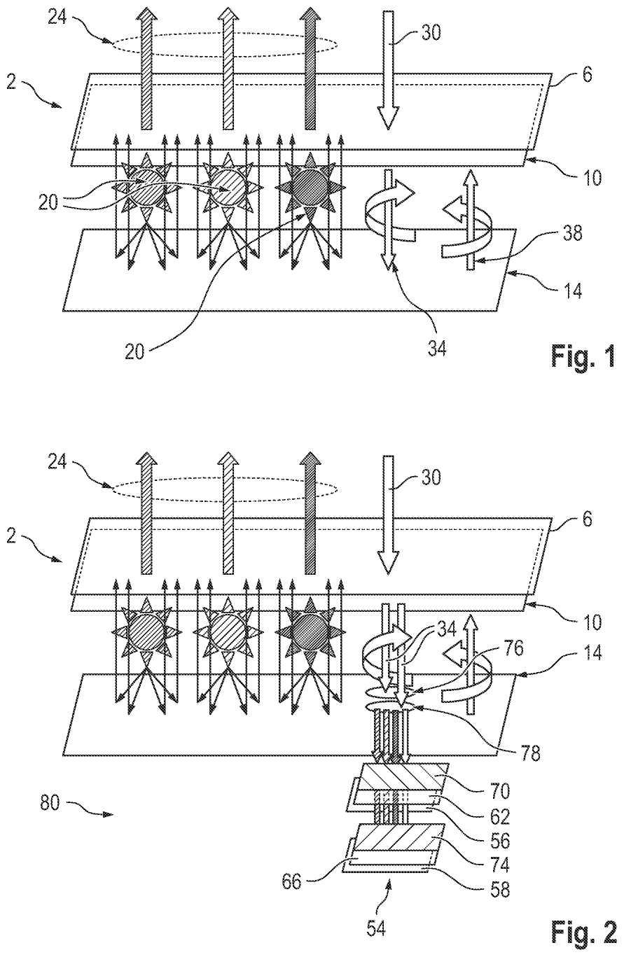

In FIG. 2, an optical sensor system 80 is shown which comprises a sensor module 54 which comprises a first sensor 56 and a second sensor 58. Above each sensor 56, 58, i.e., looking in the direction towards the OLED display 2, an optical diffuser 62, 66 is arranged, respectively, which preferably scatters/distributes light impinging the respective sensor 56, 58, thereby allowing a more accurate light measurement.

The respective diffuser 62, 66 is arranged between the respective sensor 56, 58 and the reflective backing. Both sensors 56, 58 are multispectral optical sensors which in the present embodiment shown detect light in eight channels including red (R), green (G), blue (B), cyan (C), yellow (Y), magenta (M), infrared (IR), and Clear which detects all visible wavelengths. However, eight channels are not required. A multispectral optical sensor could have any number of channels but typically have a minimum of three for detecting red, green, and blue wavelengths. Any additional channels may provide improved detection accuracy. The present invention applies to a multispectral sensor with any number of channels.

Between diffuser 62 associated with first sensor 56 and reflective backing 14, a first circular polarizer 70 is arranged. Between diffuser 66 associated with second sensor 58 and reflective backing 14, optionally a second circular polarizer 74 is arranged. Thereby, two configurations are possible which will be discussed below.

Above first sensor 56, a first aperture 76 is arranged in reflective backing 14. Above second sensor 58, a second aperture 78 is arranged in reflective backing 14. In this way, non-polarized light emitted by the display lights 20 and polarized ambient light 34 that has been polarized by circular polarizer is passing unhindered through reflective backing 14.

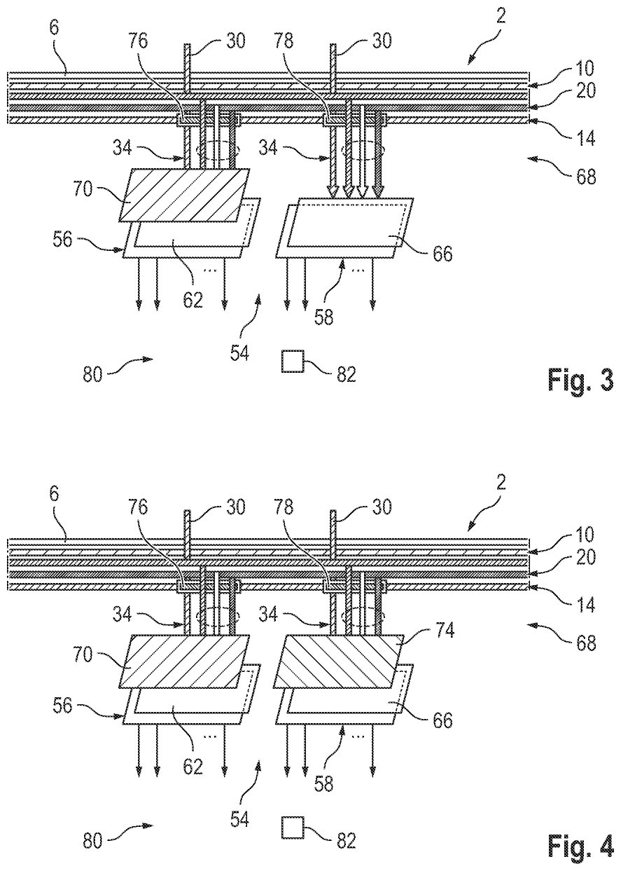

In FIG. 3, a first preferred embodiment of the optical display system 80 is shown. Above sensor 56, circular polarizer 70 is arranged which comprises a polarization direction opposite to the polarization direction of circular polarizer 10. I.e., the first sensor 56, is placed behind the circular polarizer 70 with the polarizing direction that is the opposite of the circular polarizer inside of the OLED display 2 or OLED phone. The second sensor 58 does not have a circular polarizer, i.e., it sees ambient light plus the display lights directly.

In this configuration, the first sensor 56 does not detect/sense ambient light because it is behind the circular polarizer 70 which has the opposite polarization direction of the phone circular polarizer 10 below the screen or layer 6 but above the sensor. The second sensor 58 detects/senses the polarized ambient light plus the non-polarized display light emitted by display lights 20.

A processing unit 82 is provided which is connected on the input side to both sensors 58 and is configured to compute, based on the sensor signals for each channel, for each channel an ambient light signal as described below. The processing unit, as described below, preferably is configured to further compute LUX and CCT values.

OLED display 2 and optical sensor module 54 build a display system 68. Processing unit 82 and sensors 56, 58 together are an optical sensor system 80.

In this configuration the amount of the ambient light per channel (R, G, B, C, Y, M, IR, Clear) can be determined by the formula:

per channel ambient light=per channel output of second sensor 58−f(per channel output of first sensor 56),

where f( ) is a function to be determined based on the actual device characteristics. The function f( ) can be a simple linear function such as a multiplication. The amount of the ambient light per channel (R, G, B, C, Y, M, IR, Clear) could be determined by the formula:

per channel ambient light=per channel output of second sensor 58−Ki*per channel output of first sensor 56,

where Ki is a per channel scaler, i.e., a factor.

In FIG. 4, a second preferred embodiment of an optical display system 80 is shown. The first sensor 56, like in the embodiment shown in FIG. 3, is placed behind the circular polarizer 70 with the polarizing direction that is the opposite of the circular polarizer 10 inside of the OLED display 2/OLED phone.

The second sensor 2, is in this configuration also placed behind a circular polarizer 74 with the polarizing direction that matches the direction of the circular polarizer 10 inside of the OLED display 2/OLED phone.

In this configuration, the first sensor 56 does not detect/see ambient light because it is behind the circular polarizer 70 that has the opposite direction of the phone circular polarizer 10 below the layer 6/screen but above the sensor 56. This is identical to the in configuration 1 shown in FIG. 3. The second sensor 58 sees the polarized ambient light plus the polarized display light emitted by display lights 20. In this configuration the amount of the ambient light per channel can be determined by the formula:

per channel ambient light=per channel output of sensor 2−g(per channel output of first sensor 56),

where g( ) is a function to be determined based on actual device characteristics. It can be a simple linear function such as:

per channel ambient light=per channel output of sensor 2−Gi*per channel output of sensor1,

where Gi is a per channel scaler, i.e. a factor.

The functions f( )/g( ) essentially compensate the fact that the light reaching first sensor 56 and second sensor 58 is attenuated in a different way by circular polarizers/diffusers.

From the sensor values of the first 56 and second sensor 58, the LUX and CCT values of the ambient light can be computed for example as follows. Once the per channel ambient light is obtained from above configurations, the LUX and CCT values can result as follows:
[X]
[Y]=H*R^{T}
[Z]
   where X, Y, Z are tristimulus values, H is a coefficient matrix of 3×N, and R is a channel data matrix of 1×N with each element representing the derived per channel ambient light data. N is the number of channels in the multispectral sensor.

R=[a0 a1 . . . aN−1], where ai is the per channel ambient light data

Once the tristimulus values XYZ are obtained, the corresponding CIE chromaticity coordinates x and y can be computed as:

x=X/(X+Y+Z) and y=Y/(X+Y+Z)

By applying the McCamy formula or other similar formulae, we can compute LUX and CCT values as:

LUX=Y

CCT=−449 n3+3525 n2−6823.3*n+5520.33, where n=(x−0.3320)/(y−0.1858)

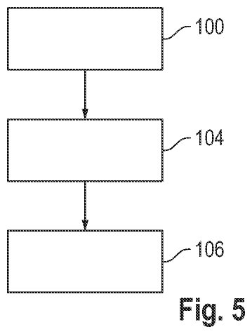

In FIG. 5, a method for ambient light detection in a preferred embodiment is shown as a flow chart. In a first box 100, light is detected by the first sensor 56, whereby the light penetrates through the circular polarizer 10 of the OLED display, the circular polarizer 70 which has a polarization detection opposite to the polarization direction of the polarizer 10 of OLED display 2. Furthermore, light is detected by the second sensor 58.

In a first variant of the method, the second sensor 58 detects light which does not pass a circular polarizer. In the second variant, the second sensor 58 detects light which passes through the circular polarizer 74 with a polarization direction that matches the polarization direction of circular polarizer 10 of the OLED display 2.

In a further box 104, a function is applied to the output signal of the first sensor 56 in each channel. This function in a preferred and simple version is a multiplication of the output signal of first sensor 56 with a real number. Applying the function to the output signal of first sensor 56 leads to a processed first signal.

In a further box 106, from the output signals of box 104 which are the processed per channel data of sensor 56 and 58, outputs representing the amount of ambient light in each channel R, G, B, C, Y, M, IR, Clear, are computed. For each channel, the ambient light output is computed by subtracting the processed first signal from the output signal of the second sensor 58.

These per-channel generated output signals representing the ambient light in each channel can be used, as described above, to calculate LUX and CCT values. They can be further processed in the device comprising the OLED display, especially a mobile device such as a smartphone or tablet, in order to adjust the intensity of the light emitted by the display lights 20 according to the characteristics of the ambient light.

### LIST OF REFERENCE SIGNS

2 OLED display
6 display layer
10 circular polarizer
14 reflective backing
20 display lights
24 polarized light
30 ambient light
34 polarized ambient light
38 polarized ambient light
54 sensor module
56 first sensor
58 second sensor
62 diffuser
66 diffuser
68 display system
70 first circular polarizer
74 second circular polarizer
76 first aperture
78 second aperture
80 optical sensor system
82 processing unit
100 box
104 box
106 box

1. An optical sensor module for detection of ambient light behind an OLED display, comprising
a first optical sensor, and
a second optical sensor,
whereby the first optical sensor is preceded by a polarizer, and
whereby both sensors are integrated into a single chip with two side by side sensing windows.

2. The optical sensor module according to claim 1, whereby the second sensor is preceded by no polarizer.

3. The optical sensor module according to claim 1, whereby the second sensor is preceded by a polarizer, and whereby the polarizing direction of this polarizer is opposite to the polarization direction of the polarizer of the first sensor.

4. The optical sensor module according to claim 1, whereby the polarizers are circular polarizers.

5. The optical sensor module according to claim 1, whereby the first sensor and/or the second sensor respectively comprises a diffuser.

6. The optical sensor module according to claim 1, whereby the sensors are multispectral sensors.

7. The optical sensor module according to claim 6, whereby the sensors detect light in the R, G, B, and/or C, Y, M, and/or IR, Clear, channels.

8. (canceled)

9. An optical sensor system, comprising an optical sensor module according to claim 1 and a processing unit which on its input side is connected to both sensors.

10. The optical sensor system according to claim 9, whereby the processing unit is configured to process both sensor signals and to generate at least one output signal.

11. The optical sensor system according to claim 10, whereby the processing unit is configured to compute per channel an ambient light signal and/or a LUX value and/or a CCT value.

12. A display system, comprising an OLED display and an optical sensor module according to claim 1.

13. The display system according to claim 12, whereby the OLED display comprises a layer, display light and a circular polarizer.

14. The display system according to claim 13, whereby the polarizer of the first sensor has a polarizing direction opposite to the polarizing direction of the polarizer of the OLED display.

15. A method for detecting ambient light behind an OLED display, whereby light is detected by two sensors arranged behind the OLED display, of which at least one sensor is preceded by a polarizer, whereby a weighted difference of both sensor signals is computed representing ambient light).
